(19) United States
(12) Patent Application Publication
(10) Pub. No.: US 2005/0066021 A1
(43) Pub. Date: Mar. 24, 2005

(54) Rule compliance

(76) Inventor: Sean M. Megley, North Attleboro, MA (US)

Correspondence Address: FISH & RICHARDSON PC, 225 FRANKLIN ST, BOSTON, MA, 02110, US

(21) Appl. No.: 10/667,532

(22) Filed: Sep. 22, 2003

(51) Int. Cl. G06F 15/173; G06F 9/45

(52) U.S. Cl. 709/223; 703/22

(57) ABSTRACT

A method for enabling a compliance officer to manage the compliance of an enterprise with one or more sets of rules includes providing an enterprise knowledge-base containing information representative of enterprise elements, and providing a rules knowledge-base containing information representative of applicable rules. A rule association is then defined between the applicable rules and the enterprise elements. Compliance scores are then defined to the rule associations. The compliance scores indicate an extent to which the enterprise elements comply with the applicable rules.

### FIELD OF INVENTION

The invention relates to systems for management of organizations, and in particular, to systems for facilitating compliance with rules.

### BACKGROUND

When one assembles pulleys, levers and motors to create a machine, the machine inevitably complies with the laws of physics. There is no need to enforce such compliance, nor is there ever a need to monitor such compliance. Since the laws of physics presumably do not change, there is never a need to redesign one or more parts of the machine to ensure continued compliance.

Like machines, business organizations, whether private, public, for profit, or non-profit, are subject to laws, and administrative rules derived from those laws. For example, health care organizations are subject to HIPAA regulations and NRC, banks are subject to banking regulations, such as FFIEC and GLBA, public corporations are subject to SEC regulations, government organizations may be subject to GAO and NIST, pharmaceutical companies are subject to FDA, EPA, and HIPAA rules, energy producers are subject to NRC and EPA rules. In addition, state and local laws may apply to such organizations.

The regulatory environment in which an organization operates is complex and changes with time. Because of the penalties associated with non-compliance, it is important to establish compliance with each rule and to maintain such compliance as the rules change and as the organization changes. The task of bringing an organization into compliance with applicable rules and maintaining such compliance is referred to as “compliance management.”

Organizations attempt to comply with these laws by instituting internal policies and procedures. However, in the case of business organizations, there is no guarantee that such procedures will cause the organization will operate in a manner consistent with those laws. In practice, the activities of an organization may comply with some laws but not with others. Or, the activities may be such that it is not whether or not compliance is achieved is ambiguous. Moreover, the laws governing organizations change from time to time.

Because of the complexity of the laws governing organizations, and because of the complexity of the organizations themselves, it is often difficult to determine whether the practices of an organization are consistent with the laws governing the organization. In many cases, evaluation of compliance, and the maintenance of such compliance, is performed on an ad hoc basis. However, because of the severe penalties associated with failure to comply with applicable law, the evaluation and monitoring of compliance is too important to be left to such ad hoc evaluation.

### SUMMARY

The invention provides a systematic approach to enabling a compliance officer to understand the extent to which an enterprise is compliant with one or more rule sets. This enables more effective compliance management and communication of compliance status to auditors.

In one aspect, the invention includes providing an enterprise knowledge-base and a rules knowledge base. The enterprise knowledge-base contains information representative of enterprise elements, and the rules knowledge-base includes information representative of applicable rules. A rule association is then defined between the applicable rules and the enterprise elements and a compliance score is assigned to each such rule association. These compliance scores are indicative of an extent to which the enterprise elements comply with the applicable rules.

Certain practices of the invention include graphically displaying the compliance scores. This can include displaying a cardinality of rule associations having a selected range of compliance scores or displaying a histogram chart of a cardinality of rule associations having each of a plurality of ranges of compliance scores. The range of compliance scores can include only a single compliance score.

Other practices of the invention include displaying a tree view of the enterprise knowledge-base. This can include the display of a compliance indicator in association with an enterprise element, the compliance indicator being indicative of a compliance score associated with the enterprise element.

The invention can also include the optional step of associating a remediation plan with the rule associations and/or providing a graphical user interface for controlling the citation process and the evaluation process.

In another aspect, the invention includes a computer-readable medium having encoded thereon software containing instructions for causing a computer to carry out the foregoing steps. As used herein, the term “medium” is not intended to be limited to a single physical structure. In particular, instructions for causing the foregoing steps can be distributed over one or more disks either on the same computer system or distributed over a network of computer systems.

In yet another aspect, the invention includes a compliance-management system having a data storage subsystem in communication with a processing subsystem. Encoded on the data storage subsystem, are an enterprise knowledge-base and a rules knowledge-base. The enterprise knowledge-base contains information representative of enterprise elements. The rules knowledge-base contains information representative of applicable rules. The processing subsystem is configured to execute a citation process and an evaluation process. The citation process defines rule associations between the applicable rules and the enterprise elements, and the evaluation process assigns compliance scores to the rule associations. These compliance scores indicate an extent to which the enterprise elements comply with the applicable rules

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE FIGURES

FIG. 1 shows the overall architecture of the compliance management system;

FIG. 2 is a data flow diagram summarizing the procedure carried out by a compliance officer using the compliance management system;

FIG. 3 shows a graphical user interface for providing access to the knowledge-bases used in connection with carrying out the method referred to in FIG. 2;

FIG. 4 shows an exemplary record from a knowledge-base accessed by an enterprise button from FIG. 3;

FIG. 5 shows an exemplary record from a knowledge-base accessed by a rules button from FIG. 3;

FIG. 6 shows an expanded tree view of the enterprise knowledge-base.

FIGS. 7-8 show exemplary graphical outputs for displaying enterprise compliance.

### DETAILED DESCRIPTION

Most enterprises operate in an environment in which they are subjected to rules. These rules may be externally imposed, for example by a government agency, or by non-governmental organizations such as unions or standard-setting organizations. Other rules may be internally generated. As used herein, the term “rule” is intended to refer broadly to all regulations, rules, laws, standards, and customary practices to which an enterprise, or one working on behalf of the enterprise, is expected to adhere.

An enterprise that operates in a manner inconsistent with one or more of these rules is referred to herein as a “non-compliant” enterprise. Conversely, an enterprise that operates in a manner consistent with all applicable rules is referred to as a “compliant” enterprise.

In practice, most enterprises will operate between full compliance and full non-compliance. Certain aspects of the enterprise's operation may be compliant with certain applicable rules. Other aspects of the enterprise's operation will be clearly non-compliant. In many cases, a gray zone exists, in which it is unclear whether an aspect of the enterprise's operation is compliant or not.

Because of the penalties associated with non-compliance, it is desirable for an enterprise to undertake a program in compliance management. Such a program typically includes a compliance audit, to ascertain the extent of non-compliance, a compliance remediation program to correct the non-compliance, and a compliance monitoring program to ensure that the enterprise avoids lapsing back into non-compliance. These compliance related activities are typically supervised by one or more persons having expertise in the field of compliance management. Such a person, or collection of persons shall be referred to herein as a “compliance officer.”

A particular aspect of an enterprise is typically only affected by a subset of the rules that govern the enterprise as a whole. A compliance management system incorporating the invention enables the compliance officer to identify those rules that apply to a selected aspect of an enterprise and to assess compliance of an enterprise on an element-by-element basis. Conversely, when a rule changes, the compliance management system enables the compliance officer to rapidly identify those elements of the enterprise that are potentially affected by the rule change.

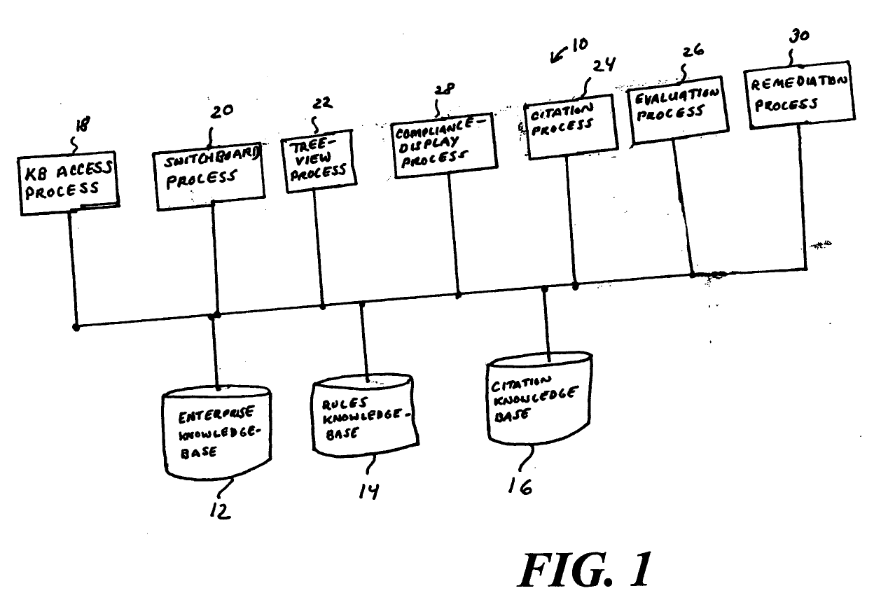

Referring to FIG. 1, a compliance management system 10 for assisting the compliance officer in establishing and maintaining compliance of an enterprise includes a data storage subsystem on which is stored an enterprise knowledge-base 12, a rules knowledge-base 14, and a citation knowledge-base 16.

The enterprise knowledge-base 12 includes information descriptive of the enterprise whose regulatory compliance is sought. The rules knowledge-base 14 includes information descriptive of all rules that the enterprise is to comply with. The citation knowledge-base 16 contains rule associations that define which rules from the rules knowledge-base 14 are to be associated with which enterprise elements from the enterprise knowledge-base 12.

The compliance management system 10 also includes a processing subsystem configured to execute a number of processes for processing information from the knowledge-bases. These processes, which are in data communication with the knowledge-bases, include:
a knowledge-base access process 18 in data communication with the knowledge-bases permits the construction and maintenance of the foregoing knowledge-bases;
a switchboard process 20 for providing a user-interface that permits the compliance officer to view the contents of the knowledge-bases on a record by record basis;
a tree-view process 22, for providing a user-interface that provides the compliance officer with a hierarchical and/or historical tree view of the knowledge-bases;
a citation process 24 for enabling the compliance officer to create rule associations between applicable rules and an enterprise element;
an evaluation process 26 for enabling a compliance officer to assign a compliance score to each rule association to indicate the extent to which the enterprise element complies with the applicable rules;
a compliance-display process 28 for providing graphical displays that enable a compliance officer to view the overall compliance status of one or more enterprise elements; and
a remediation process 30 for enabling the compliance officer to define appropriate remediation procedures for bringing an enterprise element into compliance with applicable rules.

FIG. 1 is a logical view of the compliance management system 10, and is therefore not intended to indicate the physical location of various elements of the system. For example, the knowledge-bases can reside on the same physical disk, or they can be distributed among several physical disks, some of which may be remote from each other on different computer systems. The various processes shown in FIG. 1 can likewise be executing on the same processor or on different processors. Communication between the various components of the system can be over a bus, or over a computer network.

The compliance management system 10 is implemented as an Access2002 database application using visual BASIC functions, queries, forms, and reports. However, the compliance management system 10 can also be implemented as any type of database application or as stand-alone software. In addition, the system can be implemented using client/server architecture with an SQL server.

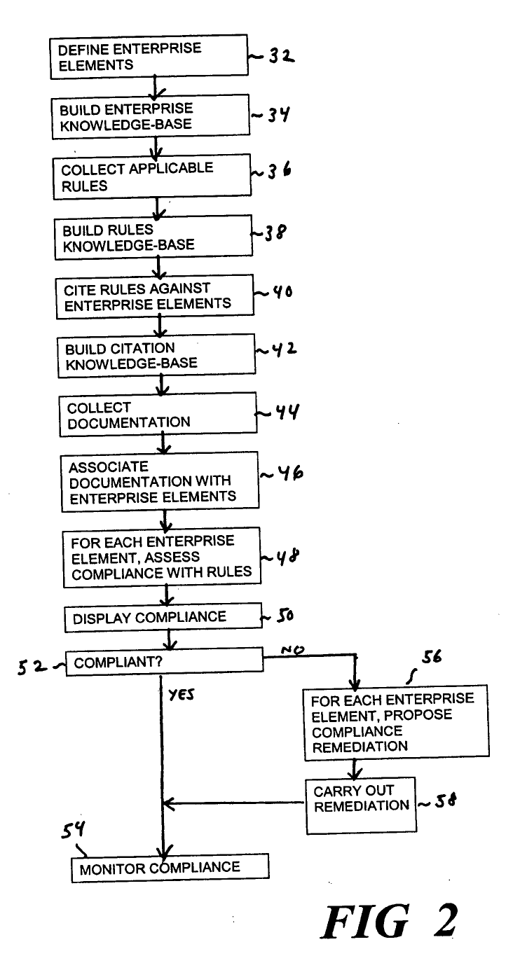

Referring now to FIG. 2, a compliance officer begins the compliance management process by identifying the constituent enterprise elements (step 32). Each such enterprise element is associated with one or more aspects of the enterprise's operation. Using the knowledge-base access process 18, the compliance officer then incorporates information concerning the enterprise elements into the enterprise knowledge-base 12 (step 34).

The particular enterprise elements vary from one enterprise to another. The compliance officer identifies the enterprise elements separately for each enterprise or class of enterprises on the basis of the regulated activities carried out by the enterprise, the organizational structure of the enterprise, and on the regulatory structure in which the enterprise operates.

The regulatory structure in which the enterprise operates includes regulations and standards imposed by government and non-government entities, and/or best practice standards that are customary within the industry or that are imposed internally. These regulatory elements are hereafter referred to collectively as “rules.” The compliance officer identifies the relevant rules (step 36) and, using the knowledge-base access process 18, organizes information about those rules into the rules knowledge-base 14 (step 38).

Having built the enterprise knowledge-base 12 and the rules knowledge-base 14, the compliance officer then uses the citation process 24 to define rule associations (step 40) between the information stored in the rules knowledge-base 14 and that stored in the enterprise knowledge-base 12. For example, for a particular rule, the compliance officer creates a rule association between that rule and those enterprise elements carrying out activities affected by that rule. The association between a rule and one or more enterprise elements is referred to herein as the “citing” of that rule. Information concerning the citation of all rules is stored in the citation knowledge-base 16 (step 42).

To assess the extent to which an enterprise element is in compliance with applicable rules, it is useful to collect compliance documentation (step 44) indicative of such compliance. Such compliance documentation can include, for example, emails, interview summaries, audit histories, activity logs, or any other evidence potentially indicative of, either directly or indirectly, compliance with rules. Using the knowledge-base access process 18, the compliance officer updates the enterprise knowledge-base 12 to identify the relevant compliance documentation and to indicate the significance of that documentation (step 46).

On the basis of the compliance documentation, the compliance officer evaluates the extent to which particular enterprise elements are in compliance with applicable rules (step 48). The compliance officer then uses the evaluation process 26 to assign a compliance score indicating the extent of such compliance.

In one embodiment, the scores correspond to those promulgated by the FFIEC (“Federal Financial Institutions Examination Council”). In this scoring standard, a score of “5” means “hazardous,” a score of “4” means “planned,” a score of “3” means “in progress,” a score of “2” means “compliant,” and a score of “1” means “best practices.” However, the number of possible scores, their values, and the meanings to be assigned to each of those values is arbitrary.

Using the compliance-display process 28, the compliance officer causes the generation of graphical displays (step 50) of the compliance scores associated with each enterprise element or group of elements. These graphical displays can be in the form of histograms showing the number of enterprise elements having compliance scores in excess of a selected value, or the number of enterprise elements having compliance scores within a range of values. As a limiting case, the range of values can include only a single value, in which case what the histogram displays is the number of enterprise elements having a compliance score equal to a particular value.

The compliance officer then determines whether the enterprise has reached a desired compliance level (step 52). Once the enterprise has done so, the compliance officer periodically audits the compliance to ensure that compliance is maintained (step 54). This is important because in some cases, an enterprise slips back into non-compliance without changing its practices, for example as a result of a rule change. In other cases, the enterprise slips back into non-compliance because of a change in the structure of the enterprise. For example, certain rules are applicable only for an enterprise having more than a threshold number of employees. Other rules are applicable to enterprises that have revenue greater than a threshold amount. An example of the latter threshold is the $500 M early revenue threshold provided by the Sarbanes-Oxley Act of 2002.

If one or more enterprise elements are non-compliant, the compliance officer uses the remediation process 30 to associate with those enterprise elements remediation procedures (step 56). These remediation procedures are noted in the enterprise knowledge-base. The remediation procedures are carried out (step 58) and compliance documents noting the remediation procedures are generated. These compliance documents are collected (step 44) and compliance is then re-assessed (step 48) in the manner set forth above.

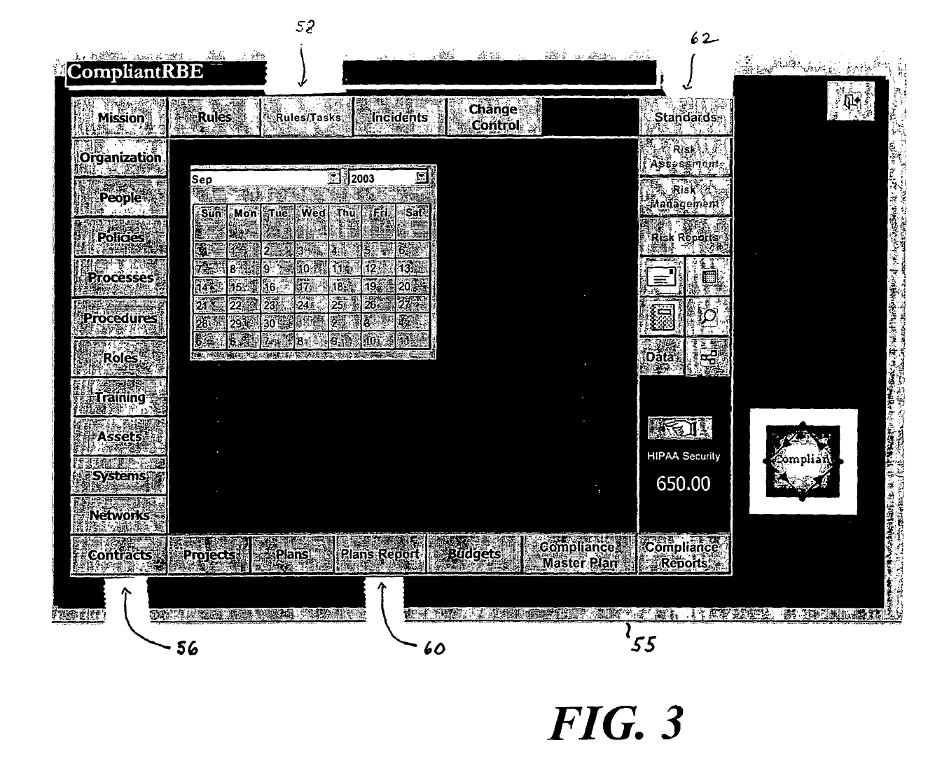

Referring now to FIG. 3, the switchboard process 20 provides a graphical user interface, referred to as a “switchboard” 54, on which is displayed enterprise buttons 56, rules buttons 58, project-governance buttons 60, and output buttons 62. The enterprise buttons 56 provide access to information in the enterprise knowledge-base 12 and the rules buttons 58 provide access to information in the rules knowledge-base 14. The project-governance buttons 60 provide access to information concerning on-going projects whose purpose is to achieve compliance of one or more enterprise elements with one or more rules. The output buttons 62 provide access to data indicative of how well the projects are achieving these goals. The switchboard process 20 can be used to initiate any of the remaining processes shown in FIG. 1 and this acts as a convenient gateway to allow the compliance officer to control those processes.

The layout of these four sets of buttons on the switchboard 54 is intended to suggest the process for achieving compliance. Starting at the top and proceeding counter-clockwise, the compliance officer applies rules, accessible through the rules buttons 58, to enterprise elements, accessible through the enterprise buttons 56, according to procedures accessible by the project-governance buttons 60 at the bottom of the switchboard 54. The output buttons 62 on the right side of the switchboard 54 then lead to displays for monitoring the success or failure of these procedures.

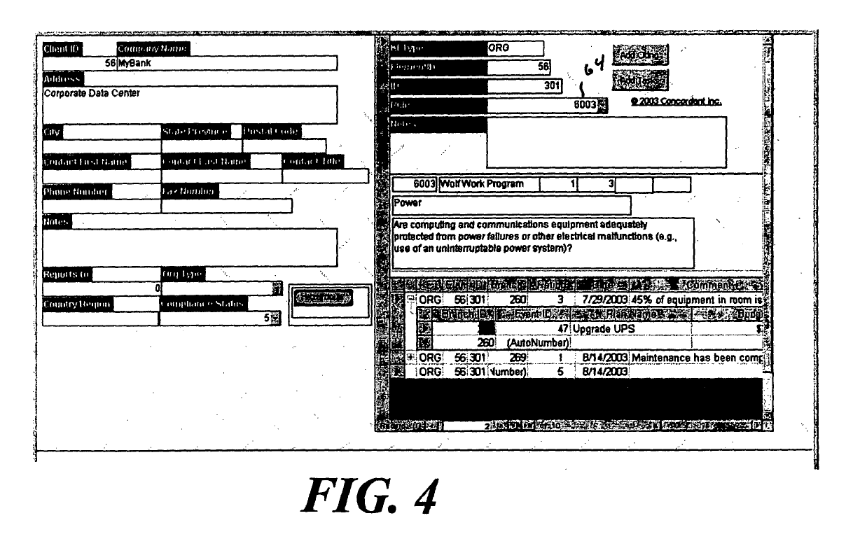

FIG. 4 shows an example of a display that is accessible by pressing one of the enterprise buttons 56, in this case the “Organization” button. The display shows a form view of one record from, in this case, a set of ten enterprise elements that are associated with the organization of the enterprise. Each record corresponds to one of the enterprise elements. Of particular significance is a drop-down list 64 of all rules that affect the displayed enterprise element.

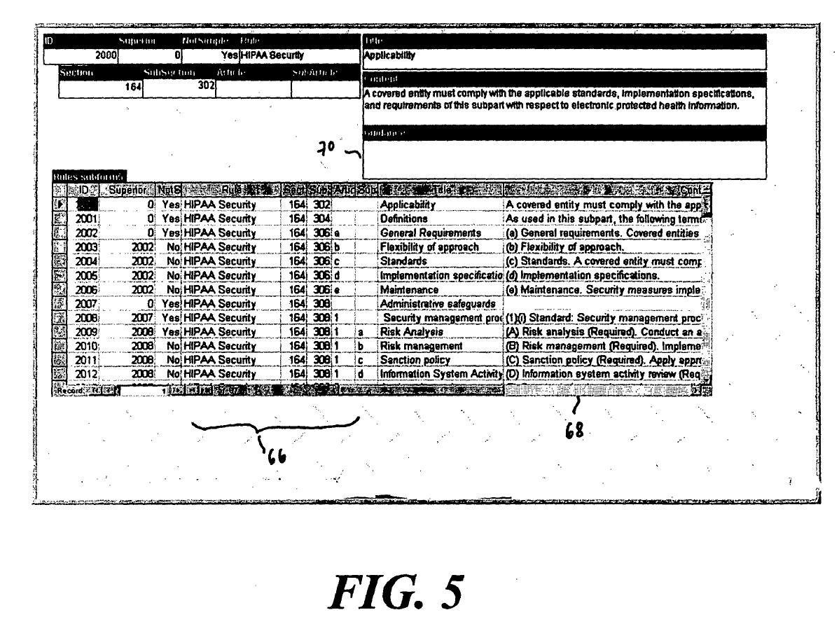

FIG. 5 shows an example of a display that is accessible by pressing one of the rules buttons 58. The display, which in this case is set to record view rather than form view, lists the rules, the sources 66 of the rules, and the text 68 of the rules. Of particular usefulness is the guidance field 70 in which the compliance officer can collect the fruit of accumulated experience associated with a selected rule.

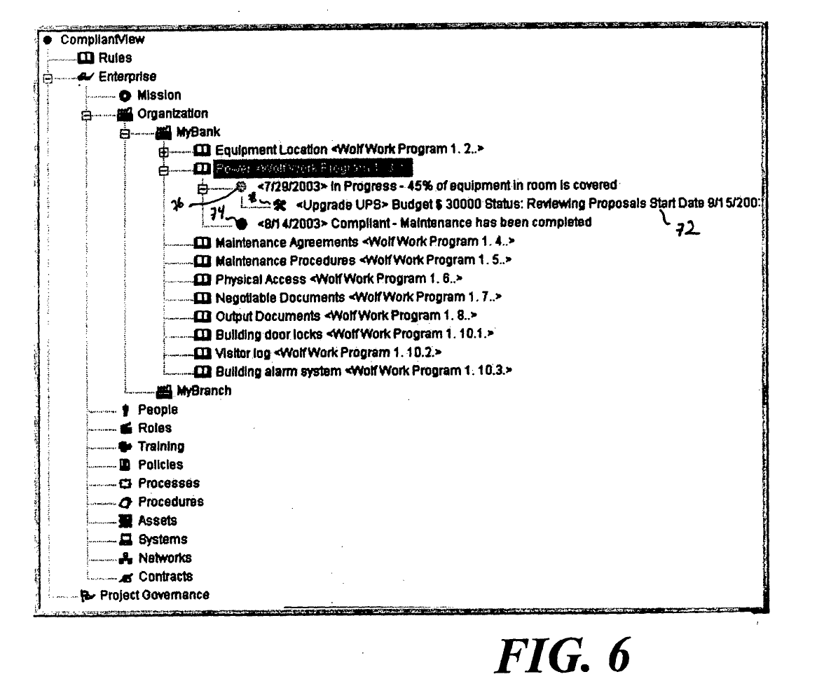

The tree-view process 20 permits graphic visualization of the enterprise and rules knowledgebase directly as trees having expandable nodes, one or more of which lead to sub-trees, as shown in FIG. 6. The compliance officer can expand and collapse sub-trees by clicking on plus and minus icons respectively. The node that is clicked on to expand a sub-tree shall be referred herein to as the “parent node” of all the nodes in the sub-tree. The nodes of the sub-tree shall be referred to herein as the “child nodes.”

When necessary, the tree-view process 20 includes an annotation adjacent to selected nodes to indicate the status of the enterprise elements associated with that node. The tree-view process 20 also provides visual cues adjacent to annotated nodes so that the existence of an annotation can readily be observed by the compliance officer. For example, in FIG. 6, which is a tree view of the enterprise knowledge-base 12, a colored visual cue 74 adjacent to the <8/14/2003> node indicates that the enterprise element associated with that node has been completed. Additional colored visual cues 76, 78, one adjacent to the <7/29/2003> node and the other adjacent to the <Upgrade UPS> node indicate both that the respective enterprise elements are non-compliant and the extent or character of such non-compliance. The extent or character of such non-compliance is communicated to the compliance officer by selecting the shape and color of the visual cue, or by providing a dynamic cue that, for example, flashes to attract attention.

When the tree is collapsed, so that child nodes are hidden under a parent node, a visual cue is provided adjacent to the parent node to indicate the compliance status of the its child nodes. In one practice, the visual cue of the parent node corresponds to the least compliant one of its child nodes. However, in other practices, the visual cue merely indicates that at least one of the child nodes is non-compliant, or the visual cue provides an indication of the average compliance of all the child nodes. To avoid visual clutter of the tree view, the visual cue for a parent node can be made to disappear upon expansion of the sub-tree for that parent node.

The display of such visual cues is recursive. A parent node that is marked by a visual cue indicative of the compliance status may itself be a child node of a grandparent node. In this case, the grandparent node will also be marked by a visual cue. The tree-view process 20 thus enables a compliance officer to see at a glance which enterprise elements require attention and which are compliant. Because visual cues are inherited by parent nodes, the compliance officer can do so regardless of which sub-trees are expanded and which are collapsed.

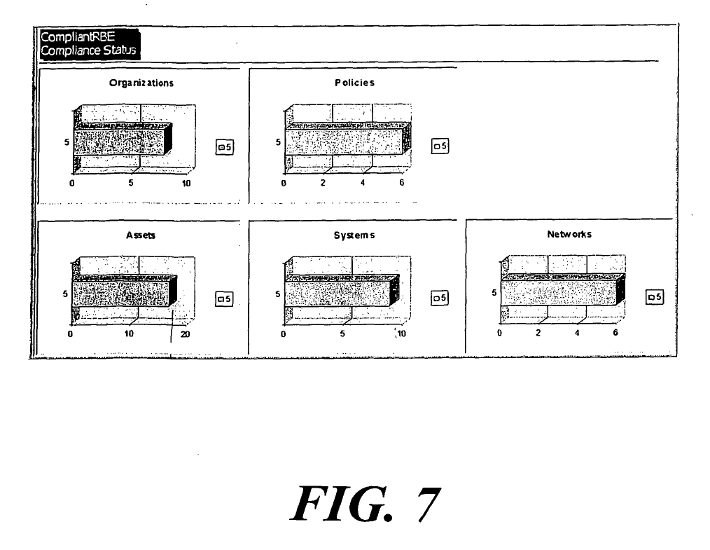

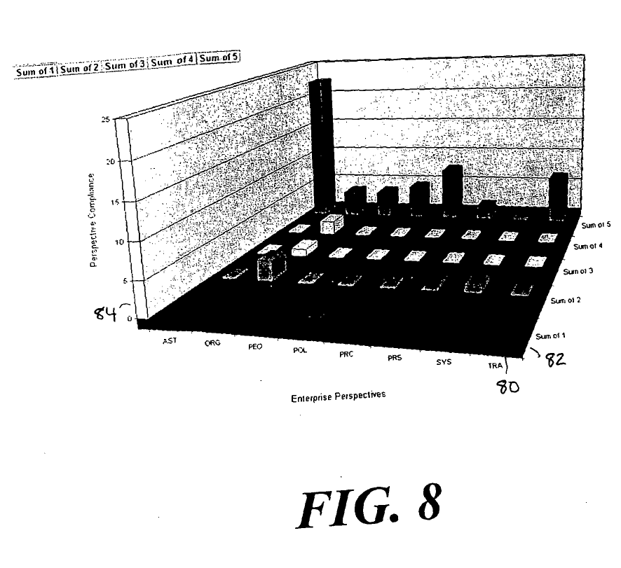

As discussed above in connection with FIG. 2, the compliance-display process 28 the compliance officer generates graphical displays of the compliance scores associated with each enterprise element or group of elements. FIGS. 7 and 8 show exemplary graphical displays.

In FIG. 7, for each set of enterprise elements, a bar extends along a horizontal axis by a distance indicative of the number of enterprise elements having the compliance score shown on the vertical axis. For example, within the set of enterprise elements associated with the organization of the enterprise, only about 80% have a compliance score of “5.” In contrast, almost 100% of the enterprise elements associated with the enterprise's policies have a compliance score of “5.” The display of FIG. 7 thus allows a compliance officer to view at a glance the compliance status of many sets of enterprise elements simultaneously.

FIG. 7 displays the number of enterprise elements having only one of the available compliance scores. FIG. 8 extends the display of FIG. 7 to include the simultaneous display of the number of enterprise elements having each possible compliance score. The first axis 80 in the graph of FIG. 8 corresponds to different sets of enterprise elements. The second axis 82 corresponds to the compliance score. The third axis 84 corresponds to the number of enterprise elements having a particular compliance score.

As an example of interpreting FIG. 8, consider the row labeled “AST.” This row corresponds to enterprise elements associated with the enterprise's assets. It is apparent that of those enterprise elements, the overwhelming majority have a compliance score of “5.” This indicates that the compliance status of most of the enterprise's assets is unknown. The enterprise elements associated with the organization of the enterprise (from the row labeled “ORG” in FIG. 8) are likewise not fully compliant. While a few have a compliance score of “5,” almost as many have a compliance score of only “2.” The graph of FIG. 8 thus rapidly provides the compliance officer with information about which sets of enterprise elements are non-compliant and the approximate extent of such non-compliance.

The system described herein can be used to achieve compliance of any enterprise with one or more sets of rules. For example, it is common for an enterprise to comply with ISO, HIPAA, and SEC rules. The application of the compliance-management system is in no way restricted to the enterprises and rules specifically described herein.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

Having described the invention, and a preferred embodiment thereof,

1. A method comprising:
providing an enterprise knowledge-base containing information representative of enterprise elements;
providing a rules knowledge-base containing information representative of applicable rules;
defining rule associations between the applicable rules and the enterprise elements; and
assigning compliance scores to the rule associations, the compliance scores being indicative of an extent to which the enterprise elements comply with the applicable rules.

2. The method of claim 1, further comprising graphically displaying the compliance scores.

3. The method of claim 2, wherein displaying the compliance scores comprises displaying a cardinality of rule associations having a selected range of compliance scores.

4. The method of claim 2, wherein displaying the compliance scores comprises displaying a histogram chart of a cardinality of rule associations having each of a plurality of ranges of compliance scores.

5. The method of claim 1, further comprising displaying a tree view of the enterprise knowledge-base.

6. The method of claim 5, wherein displaying the tree view comprises displaying a compliance indicator in association with an enterprise element, the compliance indicator being indicative of a compliance score associated with the enterprise element.

7. The method of claim 1, further comprising associating remediation policies with the rule associations.

8. The method of claim 1, further comprising providing a graphical user interface for controlling the citation process and the evaluation process.

9. A computer-readable medium having encoded thereon software having instructions that, when executed by a computer, cause the computer to:
provide an enterprise knowledge-base containing information representative of enterprise elements;
provide rules knowledge-base containing information representative of applicable rules;
define rule associations between the applicable rules and the enterprise elements; and
assign compliance scores to the rule associations, the compliance scores being indicative of an extent to which the enterprise elements comply with the applicable rules.

10. The computer-readable medium of claim 9, wherein the software further comprises instructions for causing the computer to graphically display the compliance scores.

11. The computer-readable medium of claim 10, wherein the instructions for causing the computer to display the compliance scores comprise instructions for causing the display of a cardinality of rule associations having a selected range of compliance scores.

12. The computer-readable medium of claim 10, wherein the instructions for displaying the compliance scores comprise instructions for causing the display of a histogram chart of a cardinality of rule associations having each of a plurality of ranges of compliance scores.

13. The computer-readable medium of claim 9, wherein the software further comprises instructions for causing the computer to display a tree view of the enterprise knowledge-base.

14. The computer-readable medium of claim 13, wherein the instructions for causing display of the tree view comprise instructions for causing the display of a compliance indicator in association with an enterprise element, the compliance indicator being indicative of a compliance score associated with the enterprise element.

15. The computer-readable medium of claim 9, wherein the software further comprises instructions for causing the computer to associating remediation policies with the rule associations.

16. The computer-readable medium of claim 9, wherein the software further comprises instructions for causing the computer to providing a graphical user interface for controlling the citation process and the evaluation process.

17. A compliance-management system comprising:
a data storage subsystem having encoded thereon
an enterprise knowledge-base containing information representative of enterprise elements, and
a rules knowledge-base containing information representative of applicable rules; and
a processing subsystem in data communication with the data storage subsystem, the processing subsystem being configured to execute
a citation process for defining rule associations between the applicable rules and the enterprise elements; and
an evaluation process for assigning compliance scores to the rule associations, the compliance scores being indicative of an extent to which the enterprise elements comply with the applicable rules.

18. The system of claim 17, wherein the processing subsystem is configured to execute a compliance-display process for graphically displaying the compliance scores.

19. The system of claim 18, wherein the compliance-display process is configured to display a cardinality of rule associations having a selected range of compliance scores.

20. The system of claim 18, wherein the compliance-display process is configured to display a histogram chart of a cardinality of rule associations having each of a plurality of ranges of compliance scores.

21. The system of claim 17, wherein the processing subsystem is configured to execute a tree-view process for providing a tree view of the enterprise knowledge-base.

22. The system of claim 21, wherein the tree-view process is configured to display a compliance indicator in association with an enterprise element, the compliance indicator being indicative of a compliance score associated with the enterprise element.

23. The system of claim 17, wherein the processing subsystem is configured to execute a remediation process for associating remediation policies with the rule associations.

24. The system of claim 17, wherein the processing subsystem us configured to execute a switchboard process for providing a graphical user interface for controlling the citation process and the evaluation process.
